(19) United States
(12) Patent Application Publication
(10) Pub. No.: US 2021/0086457 A1
(43) Pub. Date: Mar. 25, 2021

(54) METHOD FOR PRODUCING A BENT PART MADE OF COMPOSITE MATERIAL AND CORRESPONDING BENT PART

(71) Applicant: CORIOLIS GROUP, Quéven (FR)

(72) Inventor: Alexander HAMLYN, Ploemeur (FR)

(73) Assignee: CORIOLIS GROUP, Quéven (FR)

(21) Appl. No.: 16/613,689

(22) PCT Filed: May 15, 2018
(86) PCT No.: PCT/FR2018/000127

§ 371 Date: Nov. 14, 2019

(30) Foreign Application Priority Data
May 16, 2017 (FR) 1770499

(51) Int. Cl. B29C 70/86; B29C 70/34; B29C 70/38; B29C 70/88; B29C 65/70

(52) U.S. Cl. CPC B29C 70/86; B29C 70/347; B29C 2791/002; B29C 70/887; B29C 65/70; B29C 70/38

(57) ABSTRACT

A bent structured element and a method for producing a bent structural element comprising a first portion extending in a first direction, a second portion extending in a second direction, and a curved joining portion connecting the first portion to the second portion. The production of the bent structural element includes the production of superimposed plies by applying unidirectional continuous fibers extending longitudinally from the first portion to the second portion, and the winding of a tie around the plies in the joining portion. The bent part and a method for producing a bent part is provided comprising the production of at least two bent structural elements, and the assembly of the at least two bent structural elements in order to form the bent part.

### RELATED CASES

The present application is a National Phase entry of PCT Application No. PCT/FR2018/000127, filed May 15, 2018, which claims priority from FR Patent Application No. 1770499, filed May 16, 2017, which applications are hereby incorporated by reference in their entireties.

### TECHNICAL FIELD

The invention relates to a method for producing a bent structural element and a bent part made of composite material, and a bent structural element and a bent part of composite material obtained by the method of the invention.

### BACKGROUND ART

Bent parts, for example having an L-shaped or V-shaped section, require complex fabrication. Such bent parts, especially when profiled for hydrodynamic or aerodynamic performance, are the areas of transmission of substantial forces at the bend.

Yet bent parts made by means of conventional manufacturing processes are fragile at the bent portion. For example, in the case of parts made by bonding an extrados structure to an intrados structure, the bonding surface constitutes an area of weakness and the structure of the part does not take up the forces in the direction of the take-off of the intrados and the extrados. To solve this problem, some processes provide the bolting of the intrados and extrados but it is a complex solution to implement, expensive and unreliable.

There are known methods of producing a bent part of composite material to overcome in part the aforementioned drawbacks. These methods include making superimposed plies of fibers. However, a phenomenon of delamination or detachment of the plies occurs at the bend, especially after putting the bent part under load. This phenomenon of delamination or detachment of the plies weakens the part at the area of the bend.

Several techniques are used to prevent or delay delamination in composite material parts including the insertion before polymerization of the reinforcing rods or threads traversing the plies in the bent portion. However, these techniques are complex to implement especially for very thick parts.

### SUMMARY

The object of the invention is to propose a solution for limiting the delamination or detachment of the plies in the bent parts made of composite material.

For this purpose, embodiments of the invention propose a method of producing a bent structural element comprising a first portion extending in a first direction, also called first direction of elongation, a second portion extending in a second direction, called also a second direction of elongation, and a bent or curved joining portion connecting the first portion to the second portion, the production of the bent structural element comprising:
the production of superimposed plies by application of continuous unidirectional fibers extending longitudinally from the first portion to the second portion, and
the winding of a tie around the plies at the joining portion.

The continuous unidirectional fiber extend longitudinally from the first portion to the second portion, that is to say that the fibers extend along the first direction in the first portion and along the second direction in the second portion. The fibers are thus oriented so as to take up the main constraints of the bent structural element. The winding, also called filament winding, which is localized at the bend, makes it possible to limit the phenomenon of delamination or detachment of the plies particularly after the bent structural element is put under stress, in particular when the structural element is loaded in the direction of the opening. The method of embodiments of the invention is simple to implement, suitable for mass production, inexpensive and reliable, it enables the production of robust and lightweight bent parts.

The term bent element means, an element having a sharp angle or curvature. The bent element may have an L-shaped or V-shaped section orthogonal to the edge of the corner or the fillet of the curvature. These curved structural elements can be used to make assemblies between the wing or lift elements and beam elements transmitting the forces to the main structure.

According to a particular embodiment of the invention, the bent structural element is made by laying up, each ply is made by the application of one or more plies onto a laying up surface or on bands of the previous ply, each band being formed of one or more fibers. Laying up provides a rigid, robust and lightweight structure. The width of the band is advantageously chosen so as to make each ply by the laying up of a single band, each band being in accordance with an embodiment formed of a single fiber.

According to a particular embodiment of the invention, the width-to-thickness ratio (W/T) of the bent structural element, at least in the area of the bent portion, is at most equal to 1 and preferably at most equal to ½, even better at most equal to ⅓. The lower the width-to-thickness ratio, the more the force resulting from the tension present in the winding is exerted in the direction of the compaction of the plies between them and therefore the more the resultant force is opposed to the delamination or detachment of the plies.

The cross section of the bent structural element, which is perpendicular to the unidirectional continuous fibers, can be rectangular. According to an alternative embodiment, this cross section has a generally rectangular shape with rounded corners, for example an oblong section with two ends substantially semi-circular, in order to facilitate the winding and, depending on the type of tie, to avoid a break in the tie during winding.

According to a particular embodiment of the invention, the winding of the tie is made at 90° to the orientation of the continuous unidirectional fibers of the superposed plies. The winding comprises several turns, as well, to shift the turns relative to each other, the winding angle varies slightly during winding. Such a winding makes it possible to maintain a force on the plies counteracting delamination or detachment of the plies. The winding can be extended on either side of the winding at 90° on the first portion and the second portion, for example by a winding at +/−45° of the orientation of the fibers of the plies. The winding preferably comprises several superimposed layers or plies.

According to a particular embodiment of the invention, each ply is produced without curvature in the plane of the fiber, along a path whose projection in a plane tangent to the ply is rectilinear. That is to say that the plies are made by laying up without steering according to the English term commonly used by those skilled in the art. The absence of steering limits the presence of wrinkling in the plies, the presence of wrinkling being a factor favoring the delamination or detachment of the plies.

According to a particular embodiment of the invention, the plies are made by application by contact, by means of an application or compaction roller. The application by contact is conventionally called laying up by fibers placement. Laying up by fiber placement structurally reinforces the element produced. In fact, the fibers are compacted by means of a roller so as to ensure a sufficient cohesion between the fibers and to increase the density of the material in order to reinforce the resistance of the bent structural element to the principal stresses.

In laying-up by fiber placement, the continuous fibers are laid in contact onto the laying-up tool to form a plurality of plies in defined orientations. The fiber placement s is advantageously automated by means of a fiber placement head, known per se, comprising a compaction roller intended to come into contact with the tooling for applying a band formed of one or more continuous flat fibers, and a guiding system for guiding one or several fibers on the roller, by relative movement of the application head in relation to the laying up surface along different trajectories.

According to one embodiment, the plies are made by applying unidirectional continuous fibers onto the laying-up surface of a laying-up tool having a convex section corresponding to the concavity of the desired structural element before winding. The use of such a tool enables laying up without steering, and avoids any wrinkling of fibers that may result from a forming step.

The fibers are for example carbon fibers, glass fibers or synthetic fibers. The continuous unidirectional fibers are preferably in the form of flat continuous unidirectional fibers, conventionally called tows, comprising a multitude of filaments. The fibers have for example widths of one-eighth of an inch, one-quarter inch or one-half inch (⅛″, ¼″ or ½″). As used herein, the term «fibers» also refers to fibers of greater width, greater than ½ inch, conventionally called bands in placement technology. The fibers laid may be dry fibers provided with a binder, or fibers pre-impregnated with thermosetting or thermoplastic polymer.

According to particular embodiments of the invention, the fibers used are dry fibers provided with a binder, and/or fibers pre-impregnated with one or more thermoplastic and/or thermosetting impregnation polymers, the process furthermore comprising preferably heating the binder and/or the polymer of the fibers during and/or after the making of the plies.

According to a first embodiment, the fibers used are dry fibers, comprising less than 10% by weight of binder, preferably less than 5% by weight of binder, each bent structural element made from dry fibers being subsequently subjected to a polymer impregnation operation to form a composite element. The bent structural elements made from dry fibers with a binder comprise a small amount of binder, generally less than 5%, to maintain the cohesion of the plies of the bent structural element, while allowing its subsequent impregnation. The bent structural elements made from dry fibers are obtained by the application of dry fibers provided with a binder and/or by application of dry fibers, without binder, and application of binder, for example by spraying a liquid binder and/or spraying a binder in the form of powder, onto the application surface and/or the dry fibers previously applied. Before winding, the bent structural element is subjected to the polymer impregnation operation, for example by injection or infusion, in order to form the matrix.

According to a second embodiment, the fibers used are fibers pre-impregnated with one or more polymers, comprising at least 30% by weight of one or more thermoplastic and/or thermosetting polymers, called impregnation polymer, preferably at least 40% by weight, the polymers constituting the matrix of the final composite bent structural element. In the case of a thermosetting polymer, the bent structural element is subjected to a curing operation, preferably before the winding operation. In the case, of a thermoplastic polymer, an in situ consolidation of the polymer can be carried out during laying up and/or the bent structural element can subsequently be subjected to a consolidation operation.

According to a particular embodiment of the invention, the tie is formed of one or more fibers and/or one or more threads. The fibers or the threads of the tie are advantageously in the same material as the plies so as to enable a structural continuity in the bent structural element produced. According to one embodiment, the tie is formed of a fiber which is identical to that used for the laying up of the plies. In particular, in the case of fibers pre-impregnated with one or more polymers, the heating during the winding enables the adhesion of the fibers and/or the filaments to one another in order to reinforce the cohesion between the different layers, plies or tie, of the bent structural element produced.

According to a particular embodiment of the invention, the production of the bent structural element comprises the production of additional plies on the existing plies by application of continuous unidirectional fibers outside the joining portion. The production of additional plies makes it possible to detect a break in alignment introduced into the bent structural element by the winding. In particular in the case of an assembly of bent structural elements edge to edge, the absence of a break in alignment enables the bent structural elements to be contiguous.

Embodiments of the invention also relate to a method for producing a bent part comprising the production of at least two bent structural elements according to embodiments of the invention, and the assembly of at least two said bent structural elements by assembly means to form the bent part.

Such a method allows a modular production of bent parts by forming a structural part with several bent structural elements produced in series. The method according to the invention makes it possible to propose bent parts, in the form of long-length profiles, having good resistance to delamination, which can be used in many applications, by combining a plurality of bent structural elements, having in particular a thickness-to-width ratio less than or equal to 1. The assembly of the bent structural elements is made by mechanical assembly, preferably by bonding, the bent structural elements to each other and/or to an assembly support. According to other examples, the assembly is carried out by transverse bolting, by thermo welding or over moulding of an assembly support.

According to a particular embodiment of the invention, the assembly of at least two bent structural elements is made so that the bent structural elements are edge to edge, parallel to each other, so as to form a bent part in the form of an L-shaped profile for example. The assembly of the bent structural elements edge to edge enables one to obtain a part without material discontinuity which contributes to giving it a robust structure.

According to a particular embodiment of the invention, the method comprises the winding of a tie around at least two bent structural elements edge to edge to at least the area of the joining portions, to assemble the bent structural elements and to form a sub-assembly. The bent part is formed of a sub-assembly or of several sub-assemblies assembled together in a subsequent step.

According to a particular embodiment of the invention, the assembly of at least two bent structural elements is made in such a way that the bent structural elements are mounted on an assembly support. The assembly support constitutes for example a portion of the shell giving the bent part the desired aerodynamic or hydrodynamic shape. The bent structural elements are mounted on the assembly support by mechanical assembly for example by bolting, by bonding or by thermo welding. This particular embodiment makes it possible to distribute the bent structural elements along the bent part so as to combine on the one hand robustness and on the other hand a light weight and saving of material.

According to variants of the invention, the shell is added later to the assembly of the bent structural elements by bonding or mechanical assembly or the shell is obtained by over moulding from the bent structural elements.

According to another embodiment, bent structural elements are assembled edge to edge by their first portions, parallel to each other, two adjacent bent structural elements being arranged so that their second portions extend in opposite directions so as to form a bent part in the form of a generally T-shaped profile. The bent structural elements can be assembled to an assembly support by their second portions, the space between two second portions oriented in the same direction can be filled by a filling material, for example resin.

Embodiments of the invention also relates to a bent structural element comprising a first portion extending along a first direction, a second portion extending along a second direction, and a curved joining portion connecting the first portion to the second portion, the bent structural element comprising:
superimposed plies by application of continuous unidirectional fibers extending longitudinally from the first portion to the second portion, and
a tie wound around the plies in the joining portion.

Embodiments of invention also relate to a bent part comprising at least two bent structural elements according to embodiments of the invention assembled by assembly means to form the bent part.

Compared to the bent parts of the prior art, the bent part according to an embodiment of the invention comprises bent structural elements made in one piece without fragility or weak points at the area of the joining portion. Such parts can be used for the manufacture of profiled aerodynamic or hydrodynamic wings and in particular for the manufacture of a winglet for aircraft, or for the manufacture of a foil, a hydrodynamic appendage of the hull of a sailing boat transmitting a lifting force to the hull so as to raise it above the surface of the water.

The process according to embodiments of the invention can advantageously be used for the production of parts in the fields of sailing and shipbuilding, in the aeronautical field, in the automotive field and more generally in the transport field or in the field of energy and especially in the field of wind power.

Other characteristics and innovative advantages will emerge from the following description, provided for information only and is in no way limitative, with reference to the appended drawings.

### BRIEF DESCRIPTION OF THE DRAWINGS

FIG. 1 represents a schematic perspective view of an example of a bent structural element obtained after a first step of the method according to the invention;

FIG. 2 represents a schematic perspective view of the bent structural element of FIG. 1 after a second step of the method according to an embodiment of the invention;

FIG. 3 represents a schematic perspective view of the bent structural element of FIG. 2 after a third step of the method according to an embodiment of the invention;

FIG. 4 represents a schematic perspective view of a bent part obtained following the assembly edge to edge of bent structural elements obtained following the second step or the third step of the method according to an embodiment of the invention;

FIG. 5 represents a schematic perspective view of a bent part obtained following the assembly onto an assembly support of the bent structural elements obtained following the second step or the third step of the method according to an embodiment of the invention;

FIG. 6 is a schematic side view illustrating the laying up operation of a bent structural element;

FIG. 7 is a partial and schematic cross section of the hull of a boat with a foil made from the method of an embodiment of the invention;

FIG. 8 represents a schematic section of the foil along the cutting plane VIII-VIII of FIG. 7, the foil being produced according to a first embodiment of the invention;

FIG. 9 represents a schematic perspective view of a section of the foil in FIG. 8;

FIG. 10 represents a schematic section of the foil along the cutting plane VIII-VIII of FIG. 7, the foil being produced according to a second embodiment of the invention; and

FIG. 11 represents a schematic side view of a bent structural element before winding, used for the foil in FIG. 10.

### DETAILED DESCRIPTION

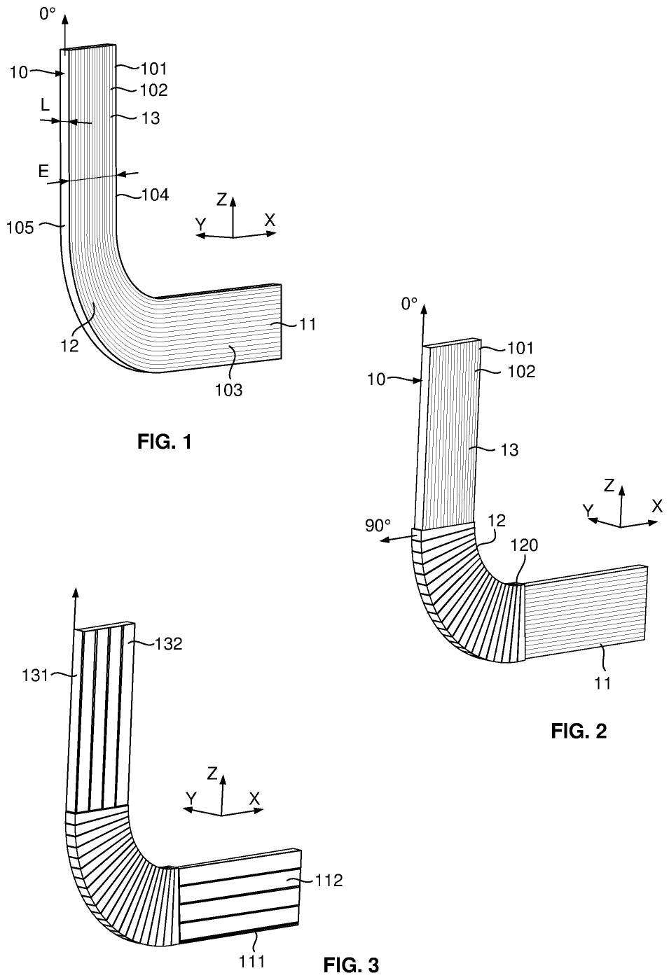

FIG. 1 illustrates an example of bent structural element 10 obtained after a first step of the method according to the invention. The bent structural element 10 has an L shape and comprises a first portion 11 extending along a first elongation direction X, a second portion 13 extending along a second elongation direction Z, the second portion 13 being connected to the first portion 11 by a curved joining portion 12.

The joining portion 12 has a sharp curvature effecting the transition between the first direction X and the second direction Z, these first and second directions being orthogonal to each other.

The bent structural element 10 consists of superimposed plies 101, 102. Each ply is formed of a band comprising a single continuous fiber having a flat ribbon shape of constant width and extending in the first direction X in the first portion 11 and along the second direction Z in the second portion 13. In the joining portion 12, the fiber follows the curvature. The bent structural element has two opposing lateral faces 103, which are here substantially planar, a concave inner face 104 and a convex outer face 105.

According to another embodiment, the bent structural element 10 has a general V shape, the joining portion connecting the first portion and the second portion so that the first portion and the second portion form an angle less than 90°, or a general flared V shape, the first portion and the second portion then forming an angle greater than 90°.

Each ply is made without curvature in the plane of the fiber, along a path whose projection in a plane tangent to the ply is rectilinear. That is to say that the plies are made by laying up without steering according to the English term commonly used by those skilled in the art. The absence of steering is for example obtained by orienting the fibers along an orientation forming at any point an angle of 90° with the fillet line or axis of curvature of the joining portion.

According to another embodiment, the first and second directions are not orthogonal to the axis of curvature of the joining portion, the fibers being inclined in relation to said axis of curvature.

The plies are superimposed in the thickness E of the bent structural element 10. The thickness is therefore orthogonal to the plane of the fibers and corresponds to the distance between the inner face 104 and the outer face 105. In the example of the figure, the width L of the bent structural element merges with the width of the fibers which constitute it and corresponds to the distance between the lateral faces 103. The smaller the width-to-thickness (W/T) ratio, the more the force resulting from the tension applied during winding is exerted in the direction of the compaction of the plies between them and therefore the more the resultant force counteracts the delamination or detachment of plies. For example, the width to thickness ratio is ¼.

As a variant, each ply comprises one or more bands, each band comprising one or more fibers.

FIG. 2 illustrates the bent structural element 10 after a second step of the method according to the invention. At the end of the second step, the bent structural element 10 further comprises a tie 120 wound around the plies 101, 102 in the joining portion 12. The tie is wound substantially along the radius of curvature so as to be at 90° to the orientation of the plies. In a variant, the tie is furthermore wound at +/−45° to the orientation of the plies on either side of the joining portion 12.

The tie is wound under tension so as to exert a compaction force on the plies in order to limit the delamination or detachment of the plies. For example, winding is performed by means of a winding machine, applying a tension ranging between 2 daN and 10 daN, preferably 5 daN to 10 daN.

The tie 120 is formed of one or more fibers and/or one or more threads. The winding is for example made with a tie consisting of a fiber pre-impregnated with a thermoplastic polymer, identical to that used to make the plies, the winding comprising for example four superimposed layers or plies, and is achieved by applying heat in order to obtain an in situ consolidation of the polymer.

FIG. 3 illustrates the bent structural element 10 after a third step of the method of the invention. At the end of the third step, the bent structural element 10 further comprises additional plies on the existing plies through the application of continuous unidirectional fibers outside the joining portion. The addition of additional plies makes it possible to fill the break in alignment introduced in the bent structural element 10 by the wound tie, in particular on its lateral faces 103 and/or its outer face 105.

One or more additional plies 112, 132 are made on each lateral face 103, firstly in the area of the first portion 11, and secondly in the area of the second portion 12, these additional plies being laid at 90° to the plies resulting from the first step. The fibers of these additional plies 112 of the first portion are here laid in the first direction X, and the fibers of these additional plies 132 of the second portion are laid in the second direction Z, each ply being for example formed of a band of four fibers. As a variant, the fibers of the additional plies of the first portion are laid in the second direction Y, and the fibers of the additional plies of the second portion are laid in the first direction X.

One or more additional plies 111, 131 are made on the outer face 105 firstly in the area of the first portion 11, and secondly in the area of the second portion 12, these plies, each formed of a fiber are parallel to the plies from the first step.

Following the subsequent use of the bent structural element, additional plies can also be provided to compensate for the break in alignment on the inner face 104.

According to an alternative embodiment, the aforementioned additional plies are made after the completion of the plies of the first step, and before winding.

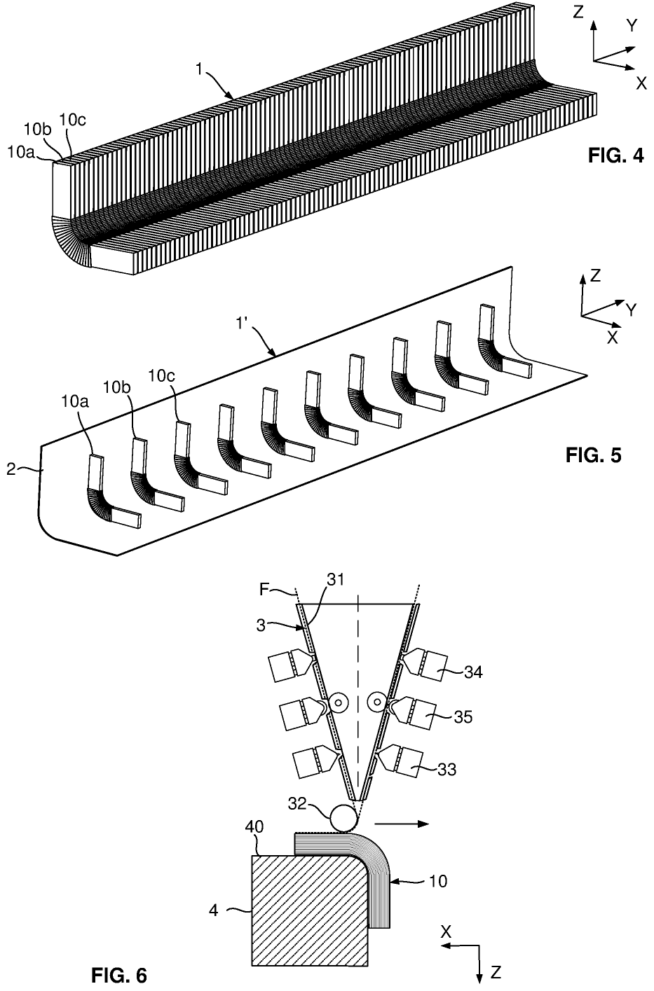

FIG. 4 illustrates a bent part 1 obtained following the assembly edge-to-edge of bent structural elements 10a, 10b, 10c obtained following the second step or the third step of the method according to embodiments of the invention. The assembly of the bent structural elements is made by mechanical assembly, for example by transverse bolting, bonding or by thermo welding. Additional plies 112, 132 on each lateral face facilitate the edge-to-edge assembly of the bent elements. As an alternative to the additional plies, the spaces between the bent structural elements generated by the winding are filled with resin during assembly.

According to a particular embodiment of the invention not shown, the method comprises the winding of a tie around at least two edge-to-edge bent structural elements obtained from the second or third step of the method.

FIG. 5 illustrates a bent part 1′ obtained following the assembly on an assembly support 2 of bent structural elements 10a, 10b, 10c obtained following the second step or the third step of the method according to the invention. The assembly support 2 constitutes a portion of the shell giving the bent part the desired aerodynamic or hydrodynamic shape, the shape having at least one curvature. The bent structural elements are mounted on the assembly support 2 by mechanical assembly for example by bolting, bonding or thermo welding. In the example, the bent structural elements are evenly distributed and positioned so that the joining portion of each bent structural element 10a, 10b, 10c matches the curvature of the bent part 1′, the outer face 105 of the structural elements being arranged facing the concave inner face of the assembly support.

According to variants of the invention, a shell is added subsequently to an assembly of bent structural elements as described with reference to FIG. 4, or the shell is obtained by over moulding on the bent structural elements, the bent structural elements being for example positioned in an injection mold, a polymer then being injected into the mold to form the shell.

FIG. 6 illustrates the first step of the method according to the invention in the case where the plies are made through application by contact, by means of an application or compaction roller. The application by contact is conventionally called laying up by fiber placement. The plies of the continuous fiber are laid on the laying up surface or application surface 40 of a laying up tool 4, the laying up surface corresponding to the shape of the desired inner face 104 of the bent structural element to be laid up, the surface comprising two planar portions connected by a convex portion corresponding to the concavity of the inner face. In reference to FIG. 6, the laying up is carried out by means of a fiber placement head 3, known per se, allowing automatic lay-up by contact of bands formed of one or more fibers. The fibers F enter the head 3 in the form of two layers of fibers, and the head comprises a guiding system 31 for guiding the fibers towards the compaction roller 32 in the form of a band of fibers in which the fibers are arranged side by side, for example substantially edge to edge. The head comprises, on either side of the guiding system, cutting means 33 for individually cutting each fiber passing through the guiding system, blocking means 34 for blocking each fiber that has just been cut, and feeding means 35 to individually feed each fiber, in order to be able to stop and resume the application of a fiber at any time, as well as to choose the width of the band. The laying up of a band is achieved by relative movement of the head in relation to the layup surface of the draping tool. The head comprises for example a support structure (not shown) on which is mounted the guiding system and by which the head can be assembled to a displacement system, adapted to move the head in at least two directions perpendicular to each other. The head is for example designed to receive four fibers, and allow the application of bands of one to four fibers of 6.35 mm (¼ inch) wide.

For example, the head is used for the production of bent structural elements, from fibers pre-impregnated with a thermoplastic polymer. The fibers are for example flat continuous carbon fibers, of the tows type, comprising a multitude of carbon threads or filaments, with a thermoplastic polymer present in quantity in the order of 40% by weight.

The head 3 is equipped with a heating system (not shown), for example of the IR lamp or laser type, in order to heat the polymer during the application of the fibers, and thus to allow at least an adhesion of the fibers of the different plies and ensure the cohesion of all the plies of the preform. The heating system heats the fibers before they are applied to the application surface, as well as the application surface or the fibers previously laid, upstream of the roller relative to the direction of advancement. Each structural element is for example formed of 100 superimposed plies, each ply being formed of one fiber. The fibers are oriented at 90° to the fillet or axis of curvature of the convex portion of the layup surface. To improve compaction via the compaction roller, shims can be added during laying up, on both sides of the laid plies, for example after each set of ten laid plies. During laying up, an in situ consolidation of the thermoplastic polymer is performed.

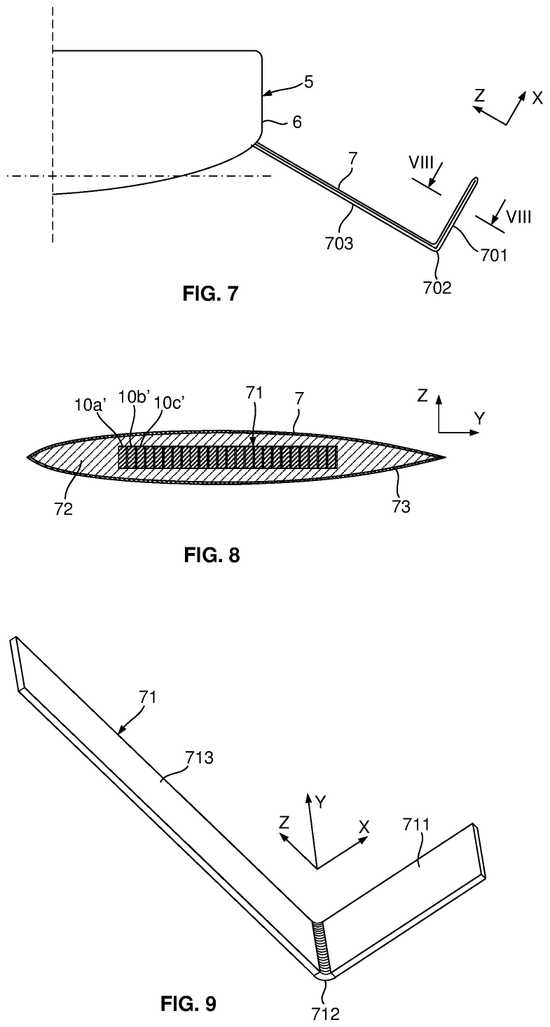

FIG. 7 represents an example of a boat 5 comprising a hull 6 equipped with foils 7, a hydrodynamic appendage of the hull of a sailing boat transmitting a lifting force to the hull so as to raise it up in relation to the surface of the water. The foil is made from a process according to the invention. In the example, the boat is a monohull sailing boat.

The foil 7 comprises two parts interconnected by a bend 702, a first part 701 constituting a lift plane and a second part 703 constituting a linking arm with the hull 6, ensuring during the operation of the boat the transmission of the forces of the righting moment and reducing the lateral motion of the boat.

FIG. 8 represents a section of the foil 7 along the cutting plane VIII-VIII of FIG. 7, the foil being made according to a first embodiment of the invention. The foil 7 comprises a bent structural part 71 formed of several bent structural elements 10′a, 10′b, 10′c assembled edge to edge. The foil further comprises a core 72 and an outer skin or shell 73, for example obtained by over moulding from the bent part 71.

FIG. 9 represents the bent structural part 71 of the foil of FIG. 8. The bent structural part 71 comprises a first portion 711 at the first portion 701 of the foil 7, the first portion 711 consisting of all the first portions of the bent structural elements 10′a, 10′b, 10′c assembled edge to edge. The bent structural part 71 further comprises a second portion 713 at the second portion 703 of the foil 7, the second portion 713 being constituted by all the second portions of the bent structural elements 10a, 10b, 10c assembled edge to edge. The bent structural part 71 also has a bent portion 712 at the bend 702 of the foil 7, the bent portion 712 being made up of all the joining portions of the bent structural elements 10′a, 10′b, 10′c assembled edge to edge. For the sake of simplification, the foil illustrated here has a simple schematic L shape. The foil can of course be formed from bent structural elements whose first and second portions form an angle other than 90°, and/or with a bent portion having a larger radius of curvature and/or whose first and/or second portions are extended by curved portions and/or planar portions.

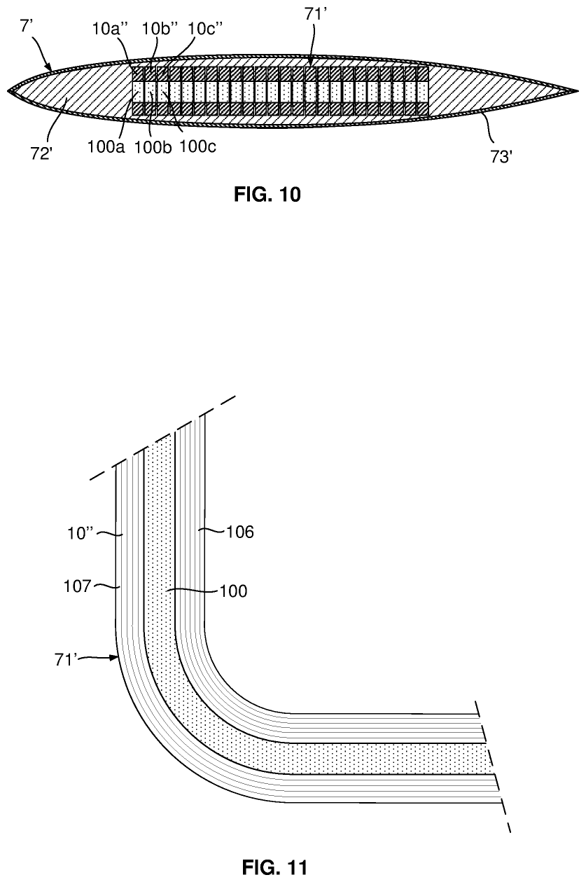

FIG. 10 illustrates a section of the foil along the cutting plane VIII-VIII of FIG. 8, the foil 7′ being made according to a second embodiment of the invention. The foil 7′ comprises a bent structural part 71′ formed as previously of several structural elements 10a″, 10b″, 10c″. In reference to FIG. 11, each bent structural element comprises a first set of plies 106 of fibers and a second set of plies 107 of fibers between which is interposed a core 100. Each structural element is for example obtained by laying up the first set of plies 106 on a lay-up tool 4, such as described above with reference to FIG. 6, positioning a core 100 on this first set of plies, preferably with an assembly by bonding the core onto the first set, and by layup of the second set of plies 107 on the core. A winding of a tie is then performed in the area of the bent portion of this bent structural element.

These resulting bent structural elements, possibly preassembled between them edge to edge by bonding, are for example placed in an injection mold in which the core 72′ and the shell 73′ are made by over moulding by injection.

The core is for example formed of a thermoplastic polymer. The core can have a honeycomb structure combining lightness and robustness.

The invention is described in the above by way of example. It is understood that one skilled in the art is able to achieve different embodiments of the invention, by associating for example the different characteristics above taken alone or in combination, without departing from the scope of the invention.

1. Method of producing a bent structural element having a first portion extending in a first direction, a second portion extending in a second direction, and a curved joining portion connecting the first portion to the second portion characterized in that the production of the bent structural element comprises:
the production of superimposed plies by applying continuous unidirectional fibers extending longitudinally from the first portion to the second portion, and
the winding of a tie around the plies in the joining portion.

2. Method according to claim 1, wherein each ply is formed by applying one or more bands onto a laying up surface or onto bands of the preceding ply, each band being formed of one or more fibers.

3. Method according to claim 1, wherein the width-to-thickness ratio (W/T) of the bent structural element is at most equal to 1, and preferably at most equal to ½, more preferably at most equal to ⅓.

4. Method according to claim 1, wherein the winding of the tie is made at 90° to the orientation of the fibers.

5. Method according to claim 1, wherein each ply is produced without curvature in the plane of the fiber.

6. Method according to any one of the preceding claims, characterized in that the plies are made by application by contact, by means of an application roller.

7. Method according to claim 1, wherein the plies are made by the application of continuous unidirectional fibers onto the lay-up surface of a laying up tool having a convex portion corresponding to the concavity of the desired structural element before winding.

8. Method according to claim 1, wherein the tie is formed of one or more fibers and/or one or more threads.

9. Method according to claim 1, comprising the production of additional plies onto the existing plies by application of continuous unidirectional fibers outside the joining portion.

10. Method for producing a bent part, wherein it comprises
the production of at least two bent structural elements according to claim 1, and
the assembly of at least two said bent structural elements to form the bent part.

11. Method according to claim 10 wherein the assembly of at least two said bent structural elements is carried out so that the bent structural elements are edge-to-edge.

12. Method according to claim 11, including the winding of a tie around at least two edge to edge bent structural elements.

13. Method according to claim 1, wherein the assembly of at least two said bent structural elements is carried out in such a way that bent structural elements are mounted on an assembly support.

14. Bent structural element comprising a first portion extending along a first direction, a second portion extending along a second direction, and a curved joining portion connecting the first portion to the second portion, characterized in that it comprises:
plies superimposed by application of continuous unidirectional fibers extending longitudinally from the first portion to the second portion, and
a tie wound around the plies in the joining portion.

15. Bent part comprising at least two bent structural elements according to claim 14 assembled by assembly means to form the bent part.
